(19) United States
(12) Patent Application Publication
(10) Pub. No.: US 2005/0154184 A1
(43) Pub. Date: Jul. 14, 2005

(54) Condensation compression molding process and apparatus for production of container preforms

(75) Inventor: Yu Shi, Alpharetta, GA (US)

Correspondence Address: SUTHERLAND ASBILL & BRENNAN LLP, 999 PEACHTREE STREET, N.E., ATLANTA, GA, 30309, US

(73) Assignee: The Coca-Cola Company

(21) Appl. No.: 11/018,723

(22) Filed: Dec. 20, 2004

Related U.S. Application Data
(60) Provisional application No. 60/535,571, filed on Jan. 9, 2004.
(60) Provisional application No. 60/521,089, filed on Feb. 19, 2004.

(51) Int. Cl. C08G 63/02

(52) U.S. Cl. 528/502 C

(57) ABSTRACT

In a method and apparatus for making a container preform comprising a poly(ethylene terephthalate) based resin, a PET based melt is fed from a condensation reactor, in which the PET based melt is made from reacting a diol component and a diacid component, to a compression mold without solidifying the PET based melt between the reactor and the compression mold.

### RELATED APPLICATIONS

This application claims priority under 35 U.S.C. §119(e) to U.S. Provisional Application 60/535,571 filed on Jan. 9, 2004 and U.S. Provisional Application 60/521,089 filed on Feb. 19, 2004, the disclosures of both of which are expressly incorporated by reference in their entirety.

### FIELD OF THE INVENTION

The invention relates to the preparation of polyester preforms for use in blow-molded containers, and more specifically, to a condensation compression molding process for making such preforms.

### BACKGROUND OF THE INVENTION

Poly(ethylene terephthalate) and its copolyesters (hereinafter collectively referred to as “PET”) have been used widely as containers for beverages, foods, pharmaceuticals and the like due to their superior barrier, mechanical and clarity properties. Traditionally, PET and the articles made from PET are made from a complicated process. PET is made from a melt polymerization process (also called condensation polymerization), followed by a pellet cutting, a pre-crystallization, a crystallization, and finally a solid-state polymerization (SSP) process due to the requirement of high molecular weight. The SSP process is normally done at temperatures from 190° to 240° C. After the PET pellets reach the required molecular weight, or intrinsic viscosity (IV), the pellets are cooled down and stored for shipment.

Those solid state polymerized pellets are then shipped to a conversion site to make container preforms through injection molding, and then containers through blow molding. In some cases, the injection and blow molding are done in one continuous process instead of two separate processes. In either case, injection molding is performed first to make the PET preforms. During injection molding, the PET pellets are first dried at temperatures of 145° C. and above to remove the moisture. Then, the dried pellets are fed directly to an extruder with a screw to transfer the solid state PET pellets and to melt the pellets to a liquid melt state. The melted PET is collected in a shooting pot and then injection molded into PET preforms.

U.S. Pat. No. 4,755,125 discloses that a compression molding process can be used to make PET preforms. During the compression molding process, the PET solid pellets are loaded into dryer to dry at temperatures above 145° C. to remove moisture, and then dried PET pellets are fed to an extruder with a screw to transfer and melt the solid state PET to liquid melt state. The melted PET is then fed to a rotary compression molding machine to make PET preforms.

During these conventional processes, several steps are repeated several times. First, melt condensation polymerization forms PET in the melt state. The melt is then cooled down to solid state and cut into pellets. The solid pellets are then heated for solid state polymerization. After that, the solid state polymerized pellets are cooled again. When these pellets are shipped to the converter's sites, they are heated yet again and melted to mold into preforms. During this whole process, energy is wasted which causes addition costs. Therefore, there is a need to simplify the process, especially to remove the redundant steps.

A continuous melt to preform process was thus developed to solve this problem. In a reported melt to preform process, PET is made to the desired IV in the melt condensation polymerization without solid state polymerization and the melt is directly fed into injection molding machine to make preforms without solidification and reheat. Therefore, several steps are removed in this process, in particular, a solid state polymerization process, a drying process, and a remelting process during the injection molding. Because this new process removed the redundant steps, it provides the advantages of much lowered cost for the final articles made from the injection molded parts.

There are three challenges for this continuous melt to preform injection molding process to work. First, the high levels of acetaldehyde (AA) generated in the melt polymerized PET needs to be removed. The solid state polymerization process normally reduces the AA level to less than 1 ppm, while the AA level from the direct melt polymerized PET without solid state polymerization is between 30 to 100 ppm depending on the polymerization process used. These AA levels are too high to be used in the beverage and some food applications. For example, in the case of water application, the AA level is recommended to be less than 3 ppm in the preform. In the case of carbonated water, it is less than 8 ppm in the preform. For carbonated soft drink, it is suggested to be less than 20 ppm in the preform. This challenge, however, can be solved by several reported methods. In particular, U.S. Pat. Nos. 5,980,797, 5,597,891, 5,968,429, and 5,656,221 all disclose a venting process to remove AA. AA is removed either through an inert gas flowing through a flash tank, or through vacuum. U.S. Pat. Nos. 4,837,115, 5,258,223, 5,650,469, 5,340,884, 5,266,416 and 6,274,212 disclose different AA scavengers to reduce AA. U.S. Pat. No. 5,656,719 discloses a combination of lower polymerization and venting to reduce the AA level.

The second challenge is to obtain high IV in the melt polymerization without solid state polymerization. Traditionally, a PET with IV of 0.5 to 0.6 dL/g is normally obtained through melt polymerization and high IV PET suitable for CSD and water application is achieved via SSP process. A SSP process is required to increase the IV to 0.72 dL/g and above for the injection blow molding container applications. Further increase in IV in the melt polymerization is limited due to the thermal degradation of PET. This can be solved via different reactor designs such as those disclosed in U.S. Pat. Nos. 3,499,873, 4,362,852, 5,648,032, 5,656,221, and 5,656,719.

The third challenge is the coupling of the continuous polymerization process to the discontinuous injection molding process. In the traditional converting process, an extruder melts and extrudes PET through an adaptor to the injection molding device. It is well known to those skilled in the art that injection molding process is a discontinuous process, in which a shooting pot is used to collect enough melt before it inject the melt into the mold for solidification. It is also known that a commercially viable melt polymerization reactor is a continuous process and any interruption in the process causes substantial lost of efficiency and money. U.S. Pat. Nos. 5,928,596 and 5,968,429 disclose complicated processes to transfer or couple the continuous melt to a discontinuous injection molding device. U.S. Pat. No. 5,968,429 discloses a complicated combination of extruder and pump for continuous melt to be transferred to a molding device. During this process, additional degradation and AA generation occurs due to the prolonged residence time in the extruder. U.S. Pat. No. 5,928,596 discloses a method and device for a timed melt transfer system. In this system, several injection molding devices are arranged and timed in a way that there is a certain amount of melt flow to one injection molder at any given time. Although U.S. Pat. No. 5,656,719 discloses a direct melt to preform process via injection molding, it does not disclose how to solve the coupling problem of the continuous melt from the condensation reactor to the discontinuous injection molder. Therefore, there exists a need in the art to have a simple process to couple the continuous melt polymerization process with the preform making process.

Although compression molding has been used for many polymers, both thermoset and thermoplastic polymers, it has not been commercially used for production of PET articles. U.S. Pat. Nos. 5,762,854, 6,506,330, 5,603,873, and 5,030,594 all disclose compression molding processes for thermoplastics, including a compression molding process to make the plastic closures used with the plastic bottles. A rotary compression molding machine is also disclosed in these patents. There are, however, very limited disclosures on the compression molding of PET preforms. JP 2003-127211 and EP 1314534 disclose a compression and injection/compression molding process to make PET preforms and U.S. Pat. No. 4,755,125 discloses a compression molding process with conventional feeding. In the above mentioned traditional compression molding processes, an extruder with a screw has to be used to transfer and melt the polymer. In the case of PET, the solid PET resin pellets are melted in the extruder and then extruded into the compression molds.

### SUMMARY OF THE INVENTION

This invention addresses the above described issues in the prior art by providing a method and apparatus for making a container preform comprising forming a poly(ethylene terephthalate) based (“PET based”) melt in a reactor via a condensation reaction and feeding the PET based melt from the reactor to a compression molder without solidifying the PET based melt between the reactor and the compression molder. The compression molder forms the PET based melt into a preform and the PET based melt is solidified in the compression mold. Thus, a condensation reactor for forming the PET based melt is directly coupled to the compression molder for forming the preform in an in-line process. This produces container preforms directly from the original PET based melt. This relatively simple process produces a PET based container preform with relatively little heat history because the PET based melt is not solidified and re-melted. The short heat history reduces the manufacturing cost to the preform and the production of acetaldehyde, which is undesirable in some applications.

### BRIEF DESCRIPTION OF DRAWINGS

FIG. 1 is a schematic illustration of a direct melt to preform condensation compression molding process in accordance with an embodiment of this invention.

FIG. 2 is a schematic illustration of a rotary compression molder for use in an embodiment of this invention.

FIG. 3 is a sectional elevational view of a compression molded container preform made in accordance with an embodiment of this invention.

FIG. 4 is a sectional elevational view of a blow molded container made from the preform of FIG. 3 in accordance with an embodiment of this invention.

FIG. 5 is a perspective view of a packaged beverage made in accordance with an embodiment of this invention.

### DETAILED DESCRIPTION OF EMBODIMENTS

As summarized above, this invention encompasses a method and apparatus for making a container preform comprising a poly(ethylene terephthalate) based (“PET based”) resin. The PET based resin is formed as a PET based melt in a condensation reactor and then fed in an in-line process from the condensation reactor to a compression molder without solidifying the PET based melt between the reactor and the compression molder. The resulting preforms can then be blow molded to make containers. The resulting preforms have a low acetaldehyde content suitable for packaging beverages such as water, carbonated soft drinks, juices, and the like.

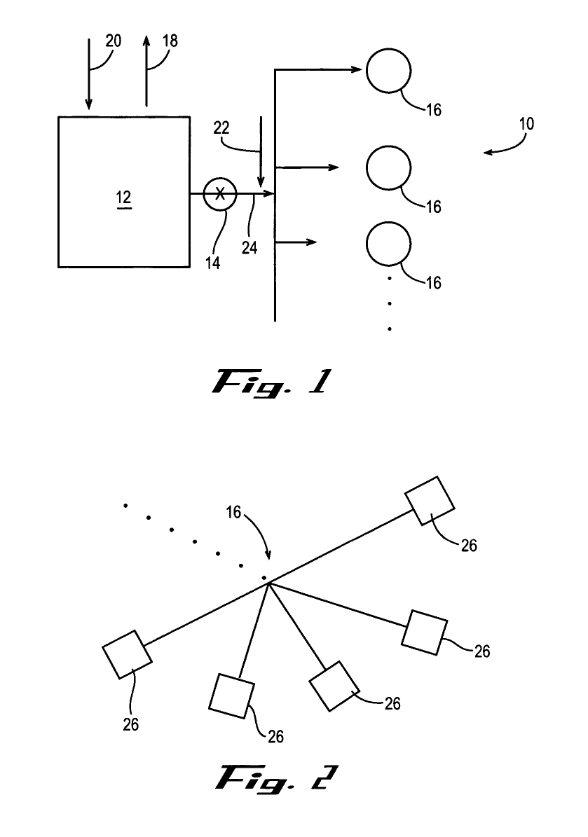

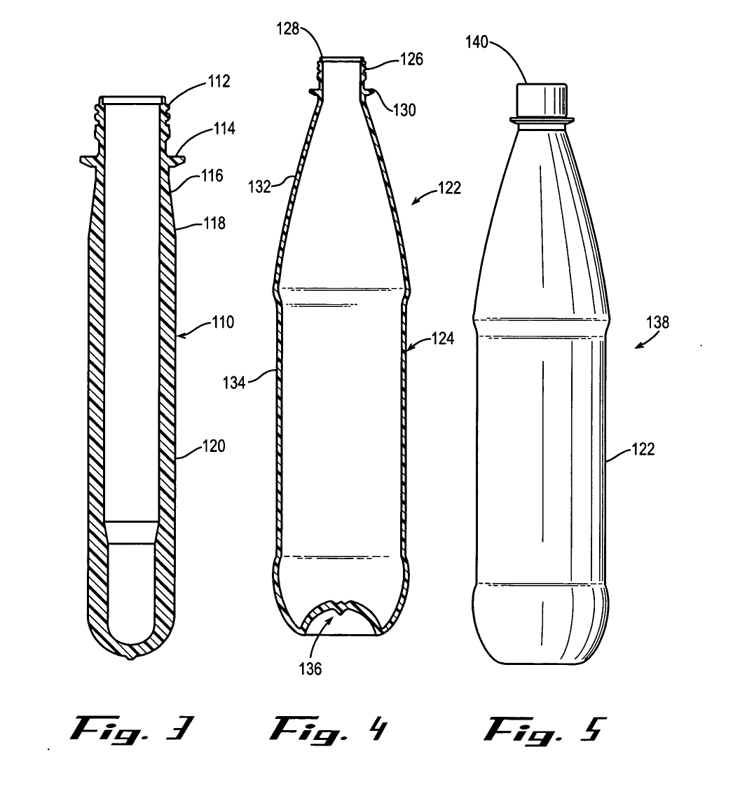

A system 10 for condensation compression molding PET based preforms in accordance with an embodiment of this invention is illustrated in FIGS. 1 and 2. Generally, this embodiment is a condensation compression molding process for producing bottle preforms from the melt of PET based resin, wherein the AA is controlled via any of the known methods disclosed in the prior arts, and the melt from the melt condensation polymerization is transferred directly to a compression molder machine and preforms are continuously produced thereafter. The system 10 comprises a condensation reactor 12 for making high IV PET based resin, a pump 14 for transporting PET based melt from the reactor, and a compression molder 16 for receiving the PET based melt and molding and solidifying the PET based melt into PET based preforms. The system also includes a degassing vent 18 for releasing acetaldehyde from the PET based melt in the reactor 12 and optionally may include acetaldehyde scavenger feeders 20 and 22 positioned to deliver such scavengers to the PET based melt in the reactor 12 and a PET based melt feed conduit 24 between the reactor and the compression molder 16.

The reactor 12 is a condensation reaction reactor for producing the PET based resin in the melt form by reacting a diol component comprising repeat units from ethylene glycol and a diacid component comprising repeat units from terephthalic acid. Preferably, the diol component comprises ethylene glycol with less than about 5 mole percent modification and the diacid component comprises terephthalic with less than about 5 mole percent diol modification, based on 100 mole percent diol component and 100 mole percent diacid component. Such reactors are well known and are capable of producing PET based resin having an IV of 0.70 and higher, desirably 0.76 and higher, and some embodiments 0.80 and higher. Desirably, the reactor 12 produces PET based resin with an IV of 0.7 to 0.9, and some embodiments 0.76 to 0.84 and in other embodiments 0.80 to 0.84. The higher IV PET based resin is desirable for some preforms. The units for IV herein are all in dL/g measured according to ASTM D4603-96, in which the IV of PET based resin is measured at 30° C. with 0.5 weight percent concentration in a 60/40 (by weight fraction) phenol/1,1,2,2-tetrachloroethane solution. Reactor designs are disclosed in U.S. Pat. Nos. 3,499,873, 4,362,852, 5,648,032, 5,656,221, and 5,656,719, the disclosures of which are expressly incorporated herein by reference.

The melt discharge from the condensation reactor 12 is fed directly to one or more compression molders 16. The PET based melt is flowable and is transported through the conduit 24 to the one or more compression molders. If necessary, the flow of the PET based melt can be aided by one or more pumps 14, but the melt does not have to be extruded for delivery to the one or more compression molders 16 because the PET based melt remains in the melt state from the reactor 12 all the way through to the one or more compression molders 16.

Acetaldehyde, which is produced in the formation of the PET based melt is reduced through known methods such as venting through the acetaldehyde vent 18 in the reactor 12 or through the addition of acetaldehyde scavenger additives through the scavenger feeders 20 and 22. Acetaldehyde venting methods and suitable acetaldehyde scavengers are well known and are not described in detail here. In particular, U.S. Pat. Nos. 5,980,797, 5,597,891, 5,968,429, and 5,656,221 all disclose a venting process to remove AA, and their disclosures are incorporated by reference in their entirety. U.S. Pat. Nos. 4,837,115, 5,258,223, 5,650,469, 5,340,884, 5,266,416 and 6,274,212 disclose different AA scavengers to reduce AA, and their disclosures are incorporated by reference in their entirety. U.S. Pat. No. 5,656,719 discloses a combination of lower polymerization and venting to reduce the AA level, and its disclosure is incorporated by reference in its entirety.

The one or more compression molders 16 can be any compression molder configured to make a PET based container preform. A preferred compression molder is a rotary compression molder comprising a wheel and a plurality of peripheral compression molds 26. Such compression molders are well known to those skilled in the art and are not discussed here in further detail. U.S. Pat. No. 4,755,125 discloses that a compression molding process can be used to make PET preforms, and its disclosure is incorporated herein by reference in its entirety.

Suitable PET based resin is any polyester composition that is commonly used for carbonated soft drink and water application. Modifiers may be added to the PET based resin in some embodiments. Suitable modifiers for terephthalic acid include but are not limited to adipic acid, succinic acid, isophthalic acid, phthalic acid, 4,4′-biphenyl dicarboxylic acid, 2,6-naphthalenedicarboxylic acid, and the like. Suitable modifiers to ethylene glycols include but are not limited to cyclohexanedimethanol, diethylene glycol, 1,2-propanediol, neopentylene glycol, 1,3-propanediol, and 1,4-butanediol, and the like.

As is well known to those skilled in the art, containers can be made by blow molding a container preform. Examples of suitable preform and container structures and are disclosed in U.S. Pat. No. 5,888,598, the disclosure of which is expressly incorporated herein by reference in its entirety.

Turning to FIG. 3, a polyester container preform 100 is illustrated. This preform 100 is made by compression molding PET based resin and comprises a threaded neck finish 112 which terminates at its lower end in a capping flange 114. Below the capping flange 114, there is a generally cylindrical section 116 which terminates in a section 118 of gradually increasing external diameter so as to provide for an increasing wall thickness. Below the section 118 there is an elongated body section 120.

The preform 100 illustrated in FIG. 1 can be blow molded to form a container 122 illustrated in FIG. 5. The container 122 comprises a shell 124 comprising a threaded neck finish 126 defining a mouth 128, a capping flange 130 below the threaded neck finish, a tapered section 132 extending from the capping flange, a body section 134 extending below the tapered section, and a base 136 at the bottom of the container. The container 100 is suitably used to make a packaged beverage 138, as illustrated in FIG. 6. The packaged beverage 138 includes a beverage such as a carbonated soda beverage disposed in the container 122 and a closure 140 sealing the mouth 128 of the container.

The preform 100, container 122, and packaged beverage 138 are but examples of applications using the preforms of the present invention. It should be understood that the process and apparatus of the present invention can be used to make preforms and containers having a variety of configurations.

It should also be understood that the foregoing relates to particular embodiments of the present invention, and that numerous changes may be made therein without departing from the scope of the invention as defined by the following claims.

1. A method for making a container preform comprising a poly(ethylene terephthalate) based resin, the method comprising:
condensation reacting a diol component comprising repeat units from ethylene glycol and a diacid component comprising repeat units from terephthalic acid in a reactor to form a poly(ethylene terephthalate) based melt;
feeding the poly(ethylene terephthalate) based melt to a compression mold without solidifying the poly(ethylene terephthalate) based melt between the reactor and the compression molder; and
compression molding and solidifying the poly(ethylene terephthalate) based melt in the compression molder to form the preform.

2. A method as in claim 1 wherein acetaldehyde is formed in the poly(ethylene terephthalate) based melt and further comprising removing at least a portion of the acetaldehyde from the poly(ethylene terephthalate) based melt.

3. A method as in claim 2 wherein the step of removing at least a portion of the acetaldehyde comprises venting the acetaldehyde.

4. A method as in claim 2 wherein the step of removing at least a portion of the acetaldehyde comprises adding an acetaldehyde scavenger to the poly(ethylene terephthalate) based melt.

5. A method as in claim 1 wherein the step of condensation reacting the poly(ethylene terephthalate) based melt has an IV of at least 0.70 dL/g.

6. A method as in claim 1 wherein the step of condensation reacting the poly(ethylene terephthalate) based melt has an IV of at least 0.76 dL/g.

7. A method as in claim 1 wherein the step of condensation reacting the poly(ethylene terephthalate) based melt has an IV of at least 0.80 dL/g.

8. A method as in claim 1 wherein the step of condensation reacting the poly(ethylene terephthalate) based melt has an IV from 0.70 to 0.90 dL/g.

9. A method as in claim 1 wherein the step of condensation reacting the poly(ethylene terephthalate) based melt has an IV from 0.76 to 0.84 dL/g.

10. A method as in claim 1 wherein the step of condensation reacting the poly(ethylene terephthalate) based melt has an IV from 0.80 to 0.84 dL/g.

11. A method as in claim 1 wherein the step of condensation reacting the poly(ethylene terephthalate) based melt the diol component comprises less than about 5 mole percent diol modification and the diacid component comprises less than about 5 mole percent modification.

12. A method as in claim 1 wherein the step of compression molding and solidifying is carried out with a rotary compression molder.

13. A method as in claim 1 wherein the step of feeding is conducted without an extruder.

14. An apparatus for making a container preform comprising a poly(ethylene terephthalate) based resin, the method comprising:
a reactor for reacting a diol component comprising repeat units from ethylene glycol and a diacid comprising repeat units from terephthalic acid in a condensation reaction to form a poly(ethylene terephthalate) based melt;
a compression molder for receiving the poly(ethylene terephthalate) based melt from the reactor and compression molding the poly(ethylene terephthalate) based melt to form the preform; and
a feeder for feeding the poly(ethylene terephthalate) based melt from the reactor to the compression molder without solidifying the poly(ethylene terephthalate) based melt between the reactor and the compression molder.

15. An apparatus as in claim 14 further comprising a vent for venting acetaldehyde from the poly(ethylene terephthalate) based melt.

16. An apparatus as in claim 14 further comprising an acetaldehyde scavenger feeder for feeding an acetaldehyde scavenger to the poly(ethylene terephthalate) based melt.

17. An apparatus as in claim 14 wherein the compression molder is a rotary compression molder.

18. An apparatus as in claim 14 wherein the poly(ethylene terephthalate) based melt feeder feeds the poly(ethylene terephthalate) based melt from the reactor to the compression molder without an extruder.
